(19) United States
(12) Patent Application Publication
(10) Pub. No.: US 2011/0242252 A1
(43) Pub. Date: Oct. 6, 2011

(54) OPTICAL HEAD AND IMAGE FORMING APPARATUS

(75) Inventors: Kazutoshi TAKAHASHI, Shizuoka-ken (JP); Koji Tanimoto, Shizuoka-ken (JP); Kenichi Komiya, Kanagawa-ken (JP); Daisuke Ishikawa, Shizuoka-ken (JP); Hiroyuki Ishikawa, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/069,267

(22) Filed: Mar. 22, 2011

Related U.S. Application Data
(60) Provisional application No. 61/320,284, filed on Apr. 1, 2010.
(60) Provisional application No. 61/320,279, filed on Apr. 1, 2010.

(51) Int. Cl. B41J 2/385; B41J 2/435; F21V 21/08; F21S 13/02

(52) U.S. Cl. 347/118; 362/457; 362/396; 347/224

(57) ABSTRACT

According to one embodiment, an optical head includes a light emitting substrate emitting light and a heat sink including a contact section in contact with an area different from a light emitting area of the light emitting substrate and a deformable section separated from the light emitting substrate and deformed according to thermal expansion of the light emitting substrate.

### CROSS-REFERENCE TO RELATED APPLICATION(S)

This application is based upon and claims the benefit of priority from: U.S. provisional application 61/320,284, filed on Apr. 1, 2010; and U.S. provisional application 61/320,279, filed on Apr. 1, 2010; the entire contents all of which are incorporated herein by reference.

### FIELD

Embodiments described herein relate generally to an optical head and an image forming apparatus.

### BACKGROUND

An optical head emits light used for exposure of a photoconductive member. The optical head includes a light emitting substrate. The light emitting substrate generates heat according to the emission of the light. When the heat is accumulated in the light emitting substrate, the light emitting efficiency of the light emitting substrate falls. Therefore, it is necessary to allow the heat of the light emitting substrate to escape from the light emitting substrate.

### DESCRIPTION OF THE DRAWINGS

FIG. 1 is a diagram of the internal structure of an image forming apparatus;

FIG. 2 is a sectional view of an optical printer head according to a first embodiment;

FIG. 3 is an external view of a light emitting substrate and a heat sink in the first embodiment;

FIG. 4 is an external view of the light emitting substrate and the heat sink in the first embodiment;

FIG. 5 is a side view of the light emitting substrate and the heat sink at the time when the light emitting substrate does not expand;

FIG. 6 is a side view of the light emitting substrate and the heat sink at the time when the light emitting substrate thermally expands;

FIG. 7 is an external view of a light emitting substrate and a heat sink in a modification of the first embodiment;

FIG. 8A is a side view of a part of the heat sink in the modification of the first embodiment;

FIG. 8B is a side view of a part of a heat sink in another modification of the first embodiment;

FIG. 9 is an external view of a light emitting substrate and a heat sink in a second embodiment;

FIG. 10 is an external view of the light emitting substrate and the heat sink in the second embodiment;

FIG. 11 is a diagram of a state in which the heat sink receives heat from the light emitting substrate and expands in the second embodiment; and

FIG. 12 is an external view of a light emitting substrate and a heat sink in a modification of the second embodiment.

### DETAILED DESCRIPTION

In general, according to one embodiment, an optical head includes a light emitting substrate emitting light and a heat sink. The heat sink includes a contact section in contact with an area different from a light emitting area of the light emitting substrate and a deformable section separated from the light emitting substrate and deformed according to thermal expansion of the light emitting substrate.

### First Embodiment

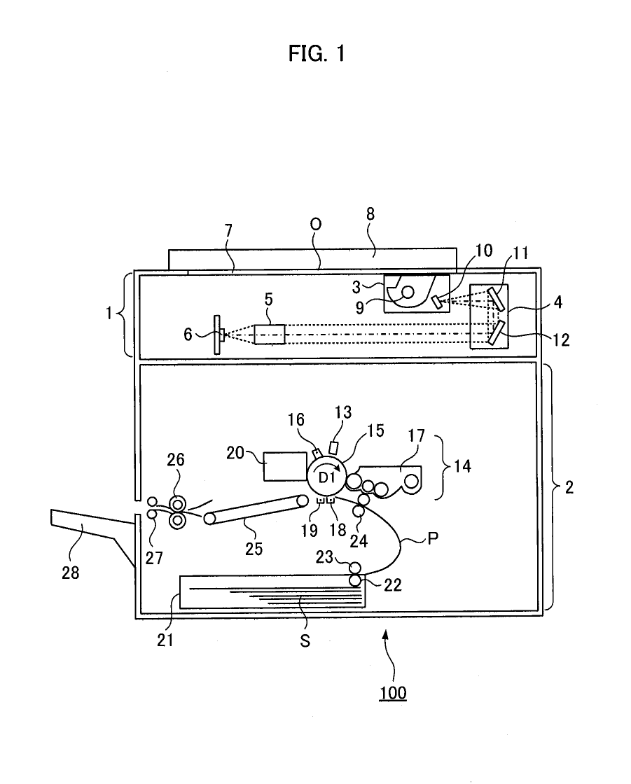

FIG. 1 is a diagram of the internal structure of an image forming apparatus. An image forming apparatus 100 includes a scanner unit 1 and a printer unit 2. The scanner unit 1 reads an image of an original document O. The printer unit 2 forms an image on a sheet.

The original document O is placed on a document table glass 7. A reading surface of the original document O is in contact with the document table glass 7. A cover 8 rotates between a position where the cover 8 closes the document table glass 7 and a position where the cover 8 opens the document table glass 7. If the cover 8 closes the document table glass 7, the cover 8 presses the original document O against the document table glass 7.

A light source 9 emits light toward the original document O. The light of the light source 9 is transmitted through the document table glass 7 and reaches the original document O. Reflected light from the original document O is reflected by mirrors 10, 11, and 12 in this order and led to a condenser lens 5. The condenser lens 5 condenses the light from the mirror 12 and focuses the light on a light receiving surface of a photoelectric conversion element 6. The photoelectric conversion element 6 receives the light from the condenser lens 5 and converts the light into an electric signal (an analog signal).

An output signal of the photoelectric conversion element 6 is output to an optical printer head 13, which is an optical head, after being subjected to predetermined signal processing. The predetermined signal processing is processing for generating image data (digital data) of the original document O. As the photoelectric conversion element 6, for example, a CCD sensor or a CMOS sensor can be used.

A first carriage 3 supports the light source 9 and the mirror 10 and moves along the document table glass 7. A second carriage 4 supports the mirrors 11 and 12 and moves along the document table glass 7. The first carriage 3 and the second carriage 4 move independently from each other and maintain optical path length from the original document O to the photoelectric conversion element 6 constant.

When the image of the original document O is read, the first carriage 3 and the second carriage 4 move in one direction. While the first carriage 3 and the second carriage 4 move in the one direction, the light source 9 emits the light on the original document O. The reflected light from the original document O is focused on the photoelectric conversion element 6 by the mirrors 10 to 12 and the condenser lens 5. The image of the original document O is sequentially read line by line in the moving direction of the first carriage 3 and the second carriage 4.

The printer unit 2 includes an image forming unit 14. The image forming unit 14 forms an image on a sheet S conveyed from a paper feeding cassette 21. Plural sheets S stored in the paper feeding cassette 21 are separated one by one by a conveying roller 22 and a separating roller 23 and conveyed to the image forming unit 14. The sheet S reaches a registration roller 24 while moving on a conveying path P. The registration roller 24 moves the sheet S to a transfer position of the image forming unit 14 at predetermined timing.

A conveying mechanism 25 moves the sheet S having the image formed thereon by the image forming unit 14 to a fixing device 26. The fixing device 26 heats the sheet S to thereby fix the image on the sheet S. A paper discharge roller 27 moves the sheet S having the image fixed thereon to a paper discharge tray 28.

The operation of the image forming unit 14 is explained below.

The optical printer head 13, a charging device 16, a developing device 17, a transfer charger 18, a peeling charger 19, and a cleaner 20 are arranged around a photoconductive drum 15. The photoconductive drum 15 rotates in a direction of an arrow D1.

The charging device 16 charges the surface of the photoconductive drum 15. The optical printer head 13 exposes the charged photoconductive drum 15 to light. The optical printer head 13 causes plural light beams to reach an exposure position of the photoconductive drum 15.

When the light beams from the optical printer head 13 reach the photoconductive drum 15, the potential in an exposed section falls and an electrostatic latent image is formed. The developing device 17 supplies a developer to the surface of the photoconductive drum 15 and forms a developer image on the surface of the photoconductive drum 15.

When the developer image reaches a transfer position according to the rotation of the photoconductive drum 15, the transfer charger 18 transfers the developer image on the photoconductive drum 15 onto the sheet S. The peeling charger 19 peels the sheet S off the photoconductive drum 15. The cleaner 20 removes the developer remaining on the surface of the photoconductive drum 15.

While the photoconductive drum 15 is rotating, formation of an electrostatic latent image, formation of a developer image, transfer of the developer image, and cleaning of the remaining developer image can be continuously performed. In other words, it is possible to continuously perform the operation for forming images on the sheet S.

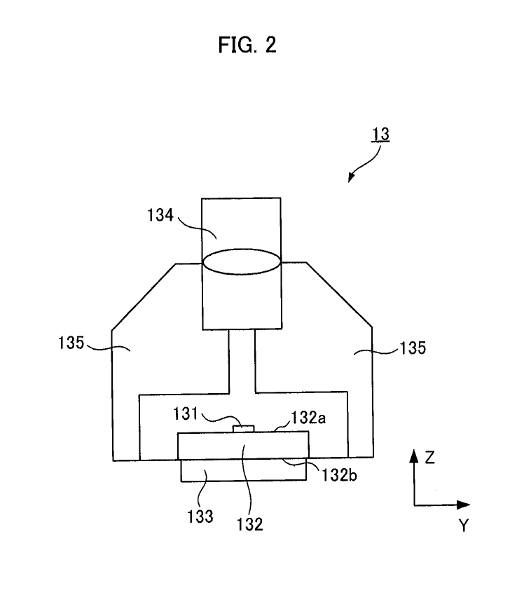

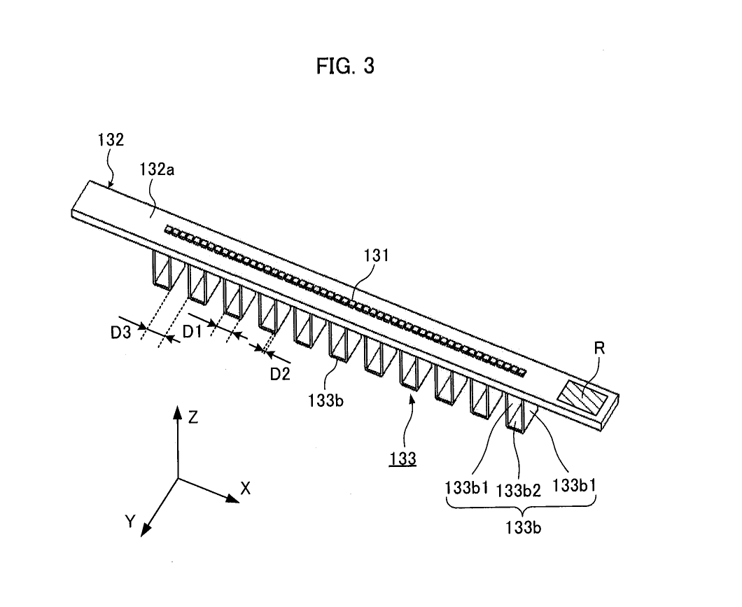

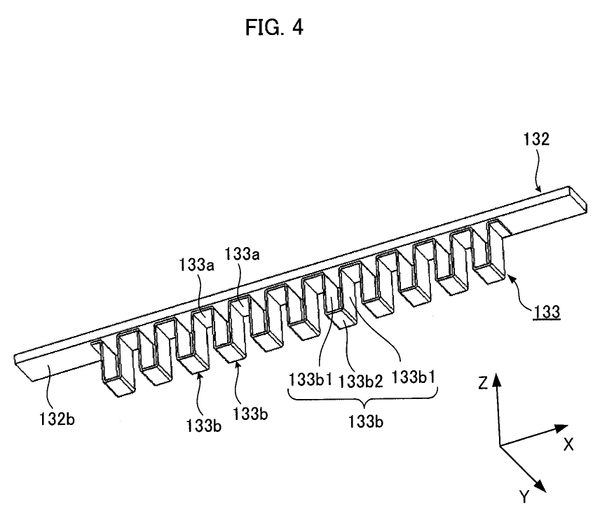

The structure of the optical printer head 13 is specifically explained with reference to FIGS. 2 to 4. FIG. 2 is a sectional view of the optical printer head 13. FIGS. 3 and 4 are external views of a light emitting substrate and a heat sink. In FIGS. 2 to 4, an X axis, a Y axis, and a Z axis are axes orthogonal to one another. In other figures, a relation among the X axis, the Y axis, and the Z axis is the same.

As shown in FIG. 3, a light emitting substrate 132 extends in an X direction and includes plural light emitting points 131. The plural light emitting points 131 are provided on a front surface 132a of the light emitting substrate 132 and arranged in a longitudinal direction of the light emitting substrate 132 (the X direction). The front surface 132a of the light emitting substrate 132 is a flat surface.

For example, if the resolution of an image formed by the image forming unit 14 is 1200 dpi, 1200 light emitting points 131 can be provided per one inch. In this embodiment, the plural light emitting points 131 are arranged in one row. However, the plural light emitting points 131 can be arranged in plural rows.

As the light emitting point 131, for example, an organic electroluminescence element or an LED (Light Emitting Diode) can be used. The light emitting substrate 132 can be formed of, for example, glass. The front surface 132a of the light emitting substrate 132 has an area R to which a wire is connected. The wire sends a driving signal of the light emitting point 131. When the light emitting point 131 emits light, in some case, heat is generated and accumulated in the light emitting substrate 132.

As shown in FIG. 2, the light emitted from the light emitting point 131 is made incident on a Selfoc lens array 134. The Selfoc lens array 134 includes plural Selfoc lenses. The plural Selfoc lenses are arranged along the longitudinal direction of the light emitting substrate 132 (the X direction). Lights emitted from the light emitting points 131 are made incident on the Selfoc lenses corresponding to the light emitting points 131.

The Selfoc lens array 134 condenses plural lights (diffused lights) from the plural light emitting points 131 and causes the lights to reach the exposure position of the photoconductive drum 15. In the exposure position of the photoconductive drum 15, spot light having desired resolution is formed. A lens holder 135 holds the Selfoc lens array 134.

A heat sink 133 is fixed to a rear surface 132b of the light emitting substrate 132 by an adhesive. The adhesive only has to be capable of bonding the heat sink 133 and the light emitting substrate 132. For example, as the adhesive, a material cured by receiving an ultraviolet ray can be used.

The rear surface 132b of the light emitting substrate 132 is a flat surface and parallel to the front surface 132a. The heat sink 133 is provided in a part of the rear surface 132b of the light emitting substrate 132. An area where the heat sink 133 is provided and an area where the plural light emitting points 131 are provided are opposed to each other in a Z direction across the light emitting substrate 132.

If the heat sink 133 is arranged right under the plural light emitting points 131, it is made easy to transmit the heat generated in the light emitting points 131 to the heat sink 133. The heat sink 133 can also be provided on the entire rear surface 132b of the light emitting substrate 132.

The heat sink 133 deprives the light emitting substrate 132 of heat and discharges the heat to the atmosphere. The heat sink 133 is formed of a material (e.g., metal) having thermal conductivity higher than that of the light emitting substrate 132. Examples of the metal material of the heat sink 133 include aluminum, stainless steel, copper, and iron.

The heat sink 133 includes contact sections 133a and deformable sections 133b. The contact sections 133a and the deformable sections 133b are alternately arranged in the X direction. The contact section 133a and the deformable section 133b adjacent to each other in the X direction are connected. The heat sink 133 (the contact sections 133a and the deformable sections 133b) is obtained by, for example, applying bending to a flat plate extending in the X direction.

The contact sections 133a of the heat sink 133 are in contact with the rear surface 132b of the light emitting substrate 132 and deprive heat of the light emitting substrate 132. The contact sections 133a and the light emitting substrate 132 are fixed by an adhesive. The adhesive only has to be capable of fixing the contact sections 133a to the light emitting substrate 132. For example, a position where the adhesive is applied can be set as appropriate.

If the contact sections 133a are in direct contact with the light emitting substrate 132, the heat of the light emitting substrate 132 can be easily transmitted to the heat sink 133. If the adhesive is applied to edges of the contact sections 133a to fix the contact sections 133a to the light emitting substrate 132, the contact sections 133a and the light emitting substrate 132 can be easily set in direct contact with each other.

The contact sections 133a fit in the rear surface 132b of the light emitting substrate 132. The contact sections 133a may project from the rear surface 132b of the light emitting substrate 132. However, in order to prevent interference with the other members, it is desirable to fit the contact sections 133a in the rear surface 132b of the light emitting substrate 132.

The deformable sections 133b of the heat sink 133 are separated from the rear surface 132b of the light emitting substrate 132. Spaces are formed on the inner sides of the deformable sections 133b. The deformable section 133b includes a pair of first areas 133b1 opposed to each other in the X direction and a second area 133b2 that connects the pair of first areas 133b1. The first areas 133b1 are present in planes orthogonal to the X direction and extend in a direction orthogonal to the rear surface 132b of the light emitting substrate 132. The second area 133b2 extends along the rear surface 132b of the light emitting substrate 132 and is orthogonal to the first areas 133b1.

D1 shown in FIG. 3 represents the length of the deformable section 133b in the X direction, in other words, a space between the pair of first areas 133b1. D2 shown in FIG. 3 represents the thickness of the heat sink 133. The thickness D2 of the heat sink 133 is smaller than the length D1 of the deformable section 133b. D3 shown in FIG. 3 represents the length of the contact section 133a in the X direction, in other words, a space between two deformable sections 133b adjacent to each other in the X direction.

The length D3 of the contact section 133a may be the same as the length D1 of the deformable section 133b or may be different from the length D1 of the deformable section 133b.

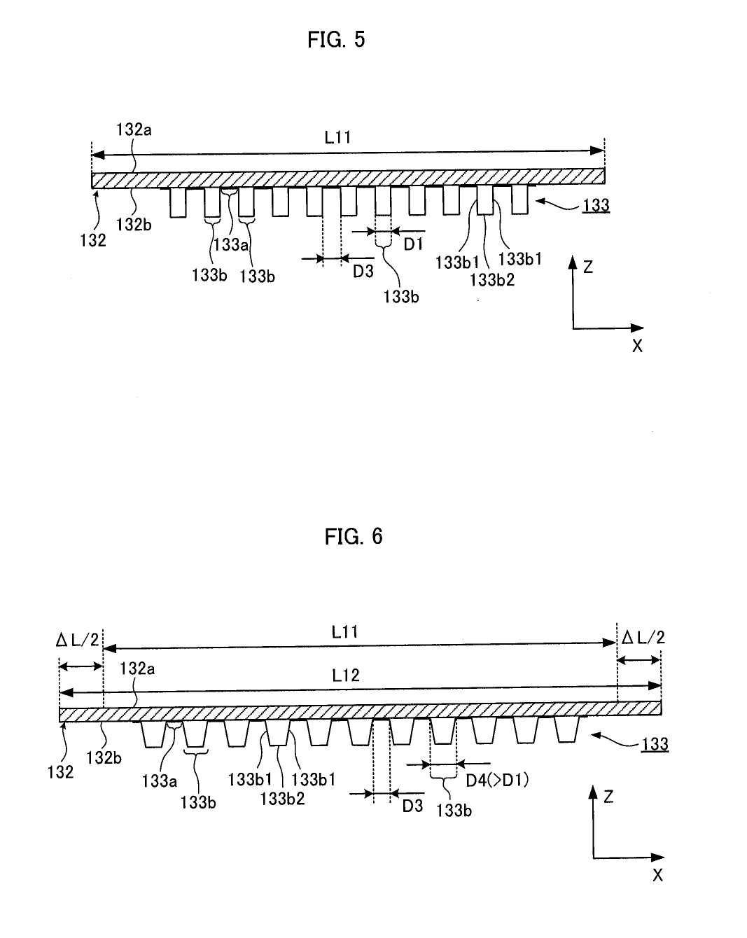

FIG. 5 is a side view of the light emitting substrate 132 and the heat sink 133 at the time when the light emitting substrate 132 does not generate heat. When the light emitting substrate 132 does not generate heat, the length of the light emitting substrate 132 in the X direction is L11.

When the light emitting substrate 132 emits light, the light emitting substrate 132 generates heat. When the temperature of the light emitting substrate 132 rises, the light emitting substrate 132 expands. FIG. 6 is a diagram of a state (an example) in which the light emitting substrate 132 thermally expands.

The light emitting substrate 132 expands in the X direction, the Y direction, and the Z direction. However, since the light emitting substrate 132 extends in the X direction, the light emitting substrate 132 easily expands in the X direction. When the light emitting substrate 132 expands, the length of the light emitting substrate 132 in the X direction is L12 larger than L11. According to the expansion of the light emitting substrate 132, both the ends of the light emitting substrate 132 in the X direction move by a displacement amount (ΔL/2) with respect to positions shown in FIG. 5.

Since the contact sections 133a of the heat sink 133 is fixed to the rear surface 132b of the light emitting substrate 132, the contact sections 133a shift in the X direction according to the expansion of the light emitting substrate 132. An area where the contact sections 133a are fixed in the light emitting substrate 132 less easily expands. Therefore, even if the light emitting substrate 132 expands, the length D3 of the contact sections 133a in the X direction less easily changes. In an area where the contact sections 133a are not fixed in the light emitting substrate 132, the expansion of the light emitting substrate 132 is allowed. If the area where the contact sections 133a are not fixed in the light emitting substrate 132 expands, the contact sections 133a shift in the X direction.

Since the deformable sections 133b are not in contact with the light emitting substrate 132, the deformable sections 133b are deformed according to the shift of the contact sections 133a in the X direction. Specifically, the first areas 133b1 of the deformable section 133b change from a state in which the first areas 133b1 extend along a Y-Z plane to a state in which the first areas 133b1 tilt with respect to the Y-Z plane. When the heat sink 133 is in a state shown in FIG. 5, the pair of first areas 133b1 in the deformable section 133b are parallel to the Y-Z plane.

If the contact sections 133a shift in the X direction according to the expansion of the light emitting substrate 132, the space between the pair of first areas 133b1 in the deformable section 133b widens. When the heat sink 133 is in a state shown in FIG. 6, the length (a maximum value) of the deformable section 133b in the X direction is D4 larger than D1.

According to this embodiment, since the heat sink 133 is fixed to the light emitting substrate 132, it is possible to allow the heat generated in the light emitting substrate 132 to escape to the heat sink 133. It is possible to suppress a temperature rise of the light emitting substrate 132.

The heat sink 133 includes the area (the contact sections 133a) in contact with the light emitting substrate 132 and the area (the deformable sections 133b) not in contact with the light emitting substrate 132. Therefore, it is possible to deform the deformable sections 133b of the heat sink 133 according to the thermal expansion of the light emitting substrate 132. If the entire heat sink 133 is in contact with the light emitting substrate 132, in some case, the light emitting substrate 132 bends because of a difference between coefficients of linear expansion of the heat sink 133 and the light emitting substrate 132.

In this embodiment, since the deformable sections 133b are deformed according to the expansion of the light emitting substrate 132, it is possible to preferentially expand the light emitting substrate 132. The thermal expansion of the heat sink 133 is less easily involved in the expansion of the light emitting substrate 132, therefore, it is possible to allow the expansion of only the light emitting substrate 132 and prevent the light emitting substrate 132 from bending.

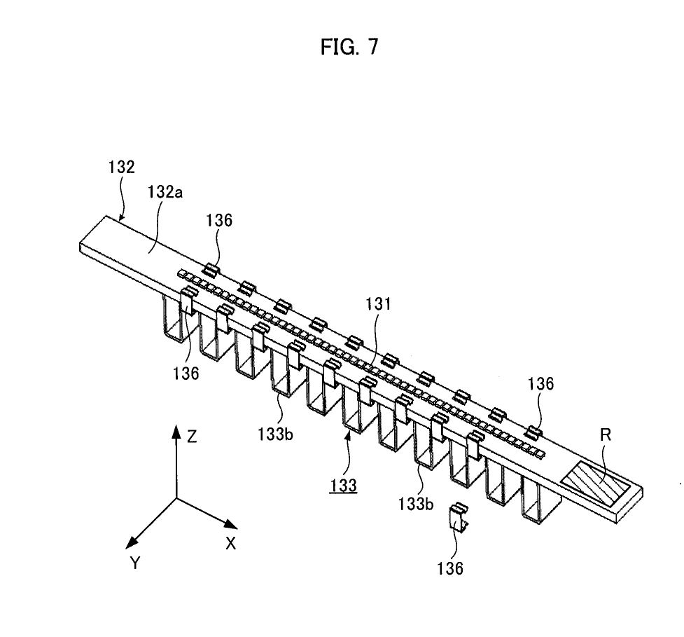

In this embodiment, the heat sink 133 is fixed to the light emitting substrate 132 using the adhesive. However, as shown in FIG. 7, the heat sink 133 can be fixed to the light emitting substrate 132 using clips 136. The clips 136 hold the contact sections 133a of the heat sink 133 and the light emitting substrate 132. The clips 136 are arranged at both the ends of the light emitting substrate 132 in the Y direction.

The clips 136 only have to be capable of holding the contact sections 133a and the light emitting substrate 132. The structure of the clips 136 can be set as appropriate. The clips 136 only have to be capable of fixing the heat sink 133 to the light emitting substrate 132. The number of the clips 136 and positions where the clips 136 are arranged can be set as appropriate.

If the clips 136 are removed, the light emitting substrate 132 and the heat sink 133 can be easily separated and the heat sink 133 can be recycled.

Besides the clips 136, a double-sided tape can be used. The double-sided tape is held between the contact sections 133a and the rear surface 132b of the light emitting substrate 132 and fixes the heat sink 133 to the light emitting substrate 132. Since the double-sided tape is arranged between the heat sink 133 and the light emitting substrate 132, it is desirable to use a material excellent in thermal conductivity. As the double-sided tape, for example, a tape, one side of which is formed of a silicon adhesive and the other side of which is formed of an acrylic adhesive, can be used.

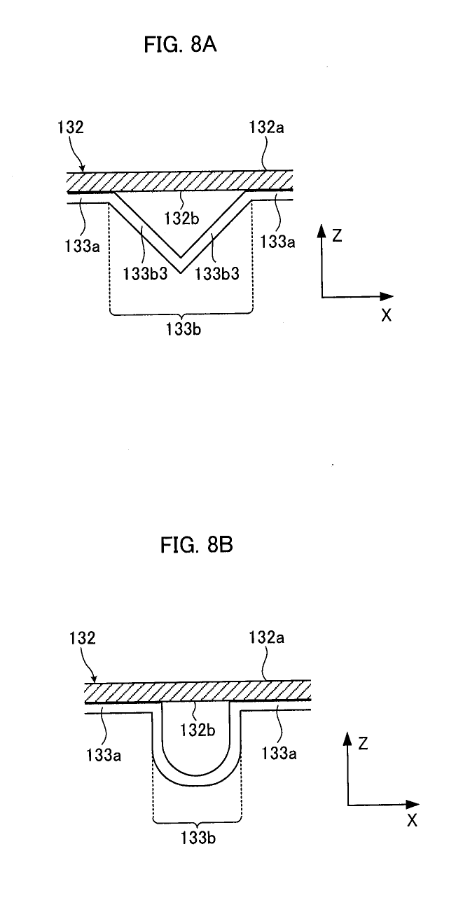

The shape of the deformable sections 133b is not limited to the shape explained in this embodiment (see FIGS. 3 to 5). The deformable sections 133b only have to be capable of allowing the thermal expansion of the light emitting substrate 132 by being deformed. For example, the shape of the deformable sections 133b can be a shape shown in FIGS. 8A and 8B.

In FIG. 8A, the deformable section 133b includes two slopes 133b3. The slopes 133b3 extend in the Y direction. In FIG. 8B, the deformable section 133b has a curved surface convex in a direction away from the rear surface 132b of the light emitting substrate 132. Even in configurations shown in FIGS. 8A and 8B, the deformable section 133b is deformed to thereby allow the thermal expansion of the light emitting substrate 132.

In this embodiment, the heat sink 133 includes the plural deformable sections 133b. However, the heat sink 133 may include only one deformable section 133b. If the heat sink 133 includes the one deformable section 133b, the deformable section 133b can be provided in a position corresponding to the center of the light emitting substrate 132 in the X direction. The number of the deformable sections 133b and positions where the deformable sections 133b are provided can be set as appropriate.

### Second Embodiment

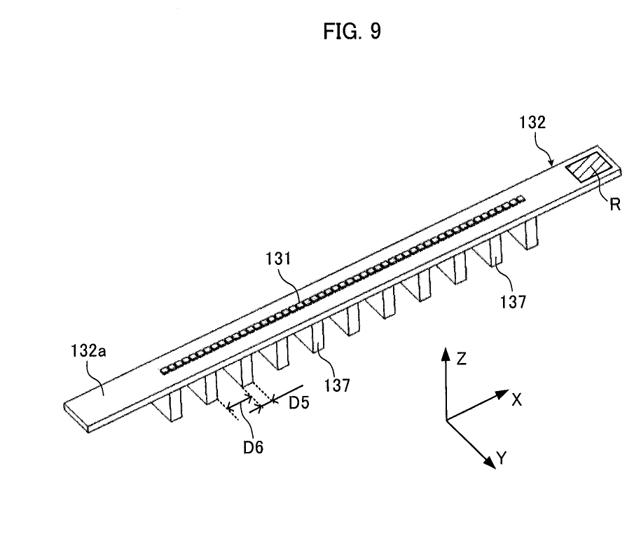

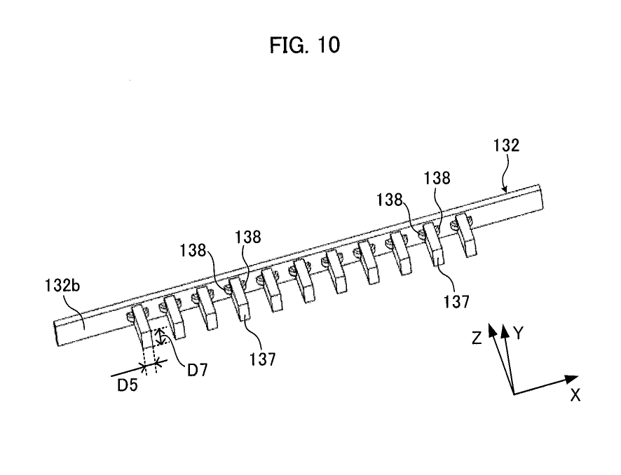

FIGS. 9 and 10 are external views of a light emitting substrate and a heat sink used in an optical printer head according to a second embodiment. In FIGS. 9 and 10, the light emitting substrate and the heat sink are viewed from directions different from each other.

A heat sink 137 is fixed to the rear surface 132b of the light emitting substrate 132 by an adhesive 138. The heat sink 137 is configured as one block. Plural heat sinks 137 are fixed to the rear surface 132b of the light emitting substrate 132.

The plural light emitting points 131 and the plural heat sinks 137 are opposed to each other across the light emitting substrate 132. Since the plural heat sinks 137 are provided in an area corresponding to the plural light emitting points 131, it is easy to allow heat of the light emitting points 131 to escape to the heat sinks 137. The heat sinks 137 can also be provided in an area not corresponding to the plural light emitting points 131.

The plural heat sinks 137 are arranged in the X direction. The heat sink 137 includes two surfaces 137a orthogonal to the X direction. The surfaces 137a of two heat sinks 137 adjacent to each other in the X direction are opposed to each other in the X direction.

Thickness D5 of the heat sink 137 in the X direction, in other words, a space D5 between the two surfaces 137a is smaller than a space D6 between the two heat sinks 137 adjacent to each other in the X direction. Length D7 of the heat sink 137 in the Y direction is larger than the thickness D5.

In this embodiment, the adhesive 138 is applied to positions on both sides of the heat sink 137 in the X direction. The adhesive 138 only has to be capable of fixing the heat sink 137 to the light emitting substrate 132. Positions where the adhesive 138 is applied can be set as appropriate. It is desirable to set the heat sink 137 in contact with the rear surface 132b of the light emitting substrate 132.

In this embodiment, the space D6 is fixed for all the heat sinks 137. However, the space D6 can be varied according to the positions of the heat sinks 137. In this embodiment, the thickness D5 is fixed for all the heat sinks 137. However, the thickness D5 may be different for the respective heat sinks 137.

According to this embodiment, it is possible to allow the heat of the light emitting substrate 132 to escape to the heat sinks 137 and suppress a temperature rise of the light emitting substrate 132. In an area where the heat sinks 137 are not fixed in the light emitting substrate 132, thermal expansion of the light emitting substrate 132 can be allowed.

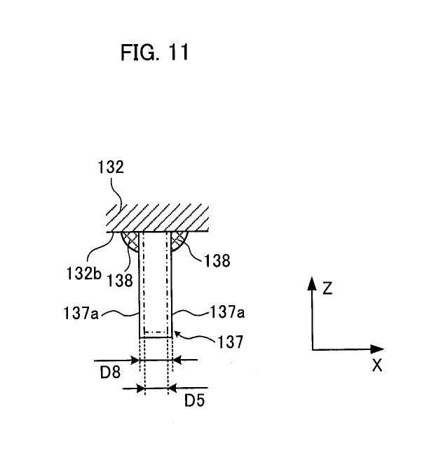

Since the heat sink 137 is configured as a block, in some case, the heat sink 137 receives the heat from the light emitting substrate 132 and slightly expands. For example, the heat sink 137 receives the heat from the light emitting substrate 132 and expands in the X direction and the thickness of the heat sink 137 changes to D8 larger than D5 (see FIG. 11).

If the adhesive 138 is formed of a material that is elastically deformed, the adhesive 138 can absorb the expansion of the heat sink 137 by being deformed. Since the adhesive 138 is deformed, the adhesive 138 can continue to fix the heat sink 137 and the light emitting substrate 132. As the adhesive 138, for example, an adhesive containing modified silicon as a main component can be used.

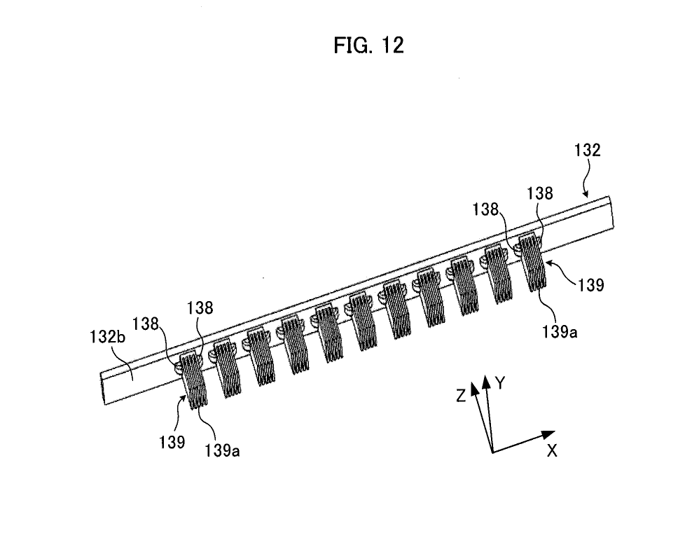

In this embodiment, the heat sink 137 is used as the block. However, as shown in FIG. 12, a heat sink 139 may include plural fins 139a. Each of the fins 139a is arranged along the Y-Z plane. The plural fins 139a are arranged in the X direction.

The shape of the fin 139a is not limited to a shape shown in FIG. 12. A surface area of the heat sink 139 only has to be capable of being increased by forming fins in the heat sink 139. If the surface area of the heat sink 139 is increased, it is possible to improve a heat radiation characteristic of the heat sink 139.

While certain embodiments have been described, these embodiments have been presented by way of example only, and are not intended to limit the scope of invention. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical head comprising:
a light emitting substrate emitting light; and
a heat sink including a contact section in contact with an area different from a light emitting area of the light emitting substrate and a deformable section separated from the light emitting substrate and deformed according to thermal expansion of the light emitting substrate.

2. The optical head according to claim 1, wherein
the light emitting substrate extends in one direction, and
the contact section and the deformable section are arranged in a longitudinal direction of the light emitting substrate.

3. The optical head according to claim 1, wherein the heat sink includes a plurality of the contact sections and a plurality of the deformable sections.

4. The optical head according to claim 3, wherein
the light emitting substrate extends in one direction, and
the contact sections and the deformable sections are alternately arranged in a longitudinal direction of the light emitting substrate.

5. The optical head according to claim 1, wherein
the light emitting substrate extends in one direction, and
the deformable section includes a pair of first areas present in a plane orthogonal to a longitudinal direction of the light emitting substrate and a second area that connects the pair of first areas.

6. The optical head according to claim 1, wherein
the light emitting substrate extends in one direction, and
length of the deformable section in a longitudinal direction of the light emitting substrate is smaller than thickness of the heat sink.

7. The optical head according to claim 1, wherein the area in contact with the contact section of the heat sink and the light emitting area are opposed to each other across the light emitting substrate.

8. The optical head according to claim 1, further comprising an adhesive that fixes the light emitting substrate and the contact section of the heat sink.

9. The optical head according to claim 1, further comprising a clip holding the light emitting substrate and the contact section of the heat sink.

10. The optical head according to claim 1, wherein the light emitting substrate includes a first plane including the light emitting area and a second plane parallel to the first plane and in contact with the heat sink.

11. An image forming apparatus comprising:
a photoconductive member;
a light emitting substrate emitting light;
a heat sink including a contact section in contact with an area different from a light emitting area of the light emitting substrate and a deformable section separated from the light emitting substrate and deformed according to thermal expansion of the light emitting substrate;
a lens leading the light, which is emitted from the light emitting substrate, to the photoconductive member and expose the photoconductive member to the light; and
a developing device supplying a developer to an exposed surface of the photoconductive member.

12. An optical head comprising:
a light emitting substrate emitting light; and
plural heat sinks fixed in an area different from a light emitting area of the light emitting substrate.

13. The optical head according to claim 12, wherein
the light emitting substrate extends in one direction, and
the plural heat sinks are arranged in a longitudinal direction of the light emitting substrate.

14. The optical head according to claim 12, wherein an area in contact with each of the heat sinks in the light emitting substrate and the light emitting area are opposed to each other across the light emitting substrate.

15. The optical head according to claim 12, wherein
the light emitting substrate extends in one direction, and
each of the heat sinks includes a surface orthogonal to a longitudinal direction of the light emitting substrate.

16. The optical head according to claim 12, further comprising an adhesive that fixes each of the heat sinks and the light emitting substrate and is elastically deformed.

17. The optical head according to claim 12, wherein each of the heat sink is a block.

18. The optical head according to claim 12, wherein each of the heat sinks includes plural fins.

19. The optical head according to claim 18, wherein
the light emitting substrate extends in one direction, and
the plural fins are arranged in a longitudinal direction of the light emitting substrate.
